(19) United States
(12) Patent Application Publication
(10) Pub. No.: US 2013/0188338 A1
(43) Pub. Date: Jul. 25, 2013

(54) ELECTRICAL SUPPLY SYSTEM FOR LIGHTING FURNITURE

(71) Applicant: Oliver Melhaff, Cologne (DE)

(72) Inventor: Oliver Melhaff, Cologne (DE)

(21) Appl. No.: 13/791,940

(22) Filed: Mar. 9, 2013

Related U.S. Application Data
(63) Continuation of application No. PCT/DE2011/001714, filed on Sep. 12, 2011.

(30) Foreign Application Priority Data
Sep. 13, 2010 (DE) DE102010045092.8

(51) Int. Cl. F21V 33/00

(52) U.S. Cl. CPC F21V 33/0012
USPC 362/127

(57) ABSTRACT

A power supply system for lighting furniture comprises at least one conducting bar having a multi-pole current-carrying capacity comprising a positive and a negative pole. A shelf can be reversibly secured to an item of furniture by means of a cylindrical peg and the lighting on the shelf is in conductive contact with the at least one conducting bar. Several axially oriented, conducting surfaces that are independent of one another and electrically insulated are provided for multi-pole current carrying and are mutually spaced around the circumference of the at least one cylindrical peg. Spring-loaded contact rails are located on the at least one conducting bar at a distance from one another for receiving the at least one cylindrical peg and providing the latter with a multi-pole current. Spring-loaded contacts are located on the shelf for receiving the at least one cylindrical peg and providing the latter with a multi-pole current.

### TECHNICAL FIELD

The present invention concerns a novel electrical supply system for the illumination of furniture, in particular but not exclusively an electrical supply system for shelf systems, cupboards, display cabinets, etc. which may be assembled and disassembled by the end customer and the height of the individual shelves of which are adjustable.

### BACKGROUND

Solutions are described in the state of the art which are difficult or impossible to integrate and which significantly affect the appearance of the furniture. For example, an electrical supply system for furniture is known from U.S. Pat. No. 6,231,205 B1 which is equipped with current-carrying rails arranged on either side of a shelf, such shelves being equipped with a lighting device and having caps on both sides in current-carrying contact with the rails. The shelves are fastened to the side walls in a manner familiar from the prior art by means of pegs reversibly insertable into the current-carrying rails, the shelves being adjustable in height.

A drawback of this system is that each rail of the furniture item supplies electrical current only via a single pole (positive pole or negative pole), requiring that at least two current-carrying rails be arranged on either side of the shelves, which is technically complex, very costly, and economically impractical. A further disadvantage is that the rails shown are slotted in from the inside (facing the usable volume), and are thus visible at all times. It is also not clear how the load-bearing function of the contact pegs is supposed to function.

In addition, the pickup (current-drawing) elements are a part of the lamp, which makes the positioning of the rails and the lighting dependent upon one another. This is inconvenient in that the holes for the front shelf supports should not, for aesthetic reasons, be located quite so visibly in the forward part of the side walls, while the lighting unit may preferably be located on the front edge of the shelves for functional reasons.

### SUMMARY

The present disclosure provides a system for supplying electrical current to furniture illumination units that is of technically simple construction, economically feasible, and which nonetheless fulfills the functional and stylistic requirements of the furniture industry.

The aforementioned objective is met in accordance with the invention with the features of claim 1. Advantageous embodiments of the electrical supply system in accordance with the invention are given in the dependent claims.

An electrical supply system of the abovementioned type is accordingly characterized by the following features, described in greater detail below:

a) At least one conducting bar arranged on the furniture item provides multipolar current transmission in the form of a positive and a negative pole.

b) Cylindrical pegs are provided to fasten a shelf in place. Multiple axially arranged conductive surfaces are distributed around the circumference at the cylindrical peg for a multipolar supply of current. These conductive surfaces are independent of one another and electrically insulated.

The pegs with the conductive surfaces are preferably positioned only on the side facing the conducting bar for fastening in place one or more shelves. For all other fastening of the particular shelf, standard commercially available pegs can be used. The cylindrical pegs preferably have the same diameter as standard commercial shelf supports and comprise in their essentials a load-bearing insulator and at least two conductive surfaces.

The conductive surfaces and the insulator are joined together through form-fitting or bonded connection methods such as gluing, welding, etc. Alternatively, hybrid methods such as injection molding may be used.

c) Spaced along the conducting bar are sprung or spring-loaded electrical contact rails for receiving the at least one cylindrical peg so as to permit a multipolar supply of current.

The axial arrangement of the conductive surfaces on the pegs permits the sprung or spring-loaded electrical contact rails to be arranged in one level facing the conducting bar and the installation dimensions of the conducting bar to be kept very flat. A considerably deeper installation space would be required for a standard round and multipolar plug form. In this way, even with a cross-section of thin standard dimensions, the side wall is only minimally weakened, and load-carrying capacity is simultaneously improved through the presence of more material in the drilled holes, reducing contact pressure. All necessary processing steps can be reconciled with the modern production methods of the furniture industry.

d) Sprung or spring-loaded electrical contacts for receiving the at least one cylindrical peg so as to permit a multipolar supply of current are also provided on the shelves or on a current collector specifically intended for such purpose. These electrical contacts can or could be integrated (or inset) directly into the shelves or fastened via a separate current collector (also retroactively) to or into the shelves.

### BRIEF DESCRIPTION OF THE DRAWINGS

Further objectives, features, advantages, and potential applications of the electrical supply system may be discerned from the following description of an exemplary embodiment by means of the drawings.

Depicted in the drawings are:

FIG. 1, an exploded perspective view of the electrical supply system;

FIG. 2, the electrical supply system of FIG. 1 in assembled form;

FIG. 3, a conductive peg in perspective view;

FIG. 4, a sectional view of the electrical supply system of FIG. 2;

FIG. 5, the depiction of a conducting bar with continuous electrical contacts which are slotted at regular intervals.

### DETAILED DESCRIPTION

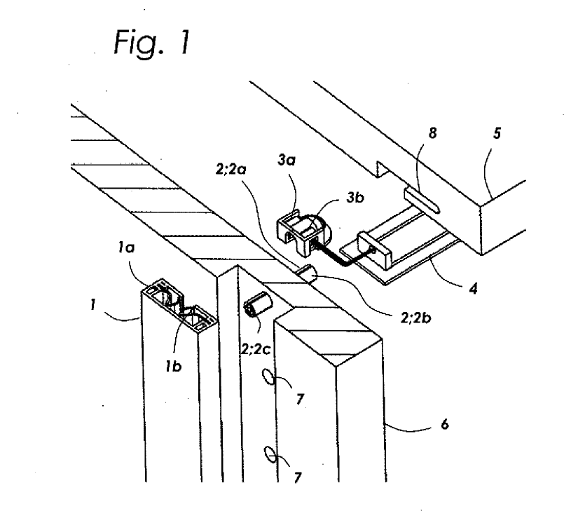

FIG. 1 shows an exploded perspective view of the electrical supply system in accordance with the invention. A conducting bar 1 in this embodiment is inset vertically from outside into one of two side walls 6 of the item of furniture or completely and invisibly integrated. The conducting bar 1 is contacted by means of several pegs 2 through the standard drill holes 7 for shelf supports located in the side walls 6.

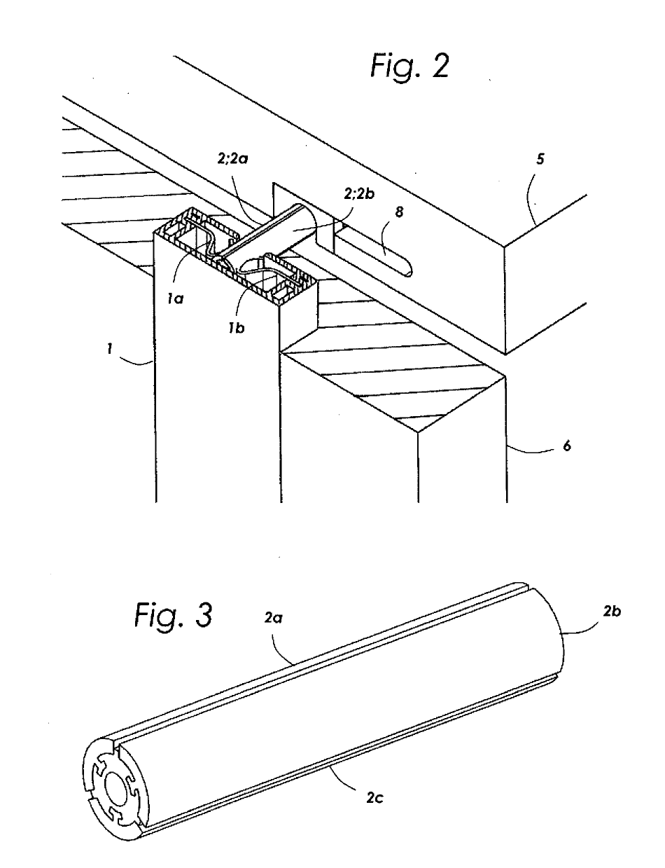

FIG. 2 illustrates the electrical supply system depicted in FIG. 1 in its assembled state. As illustrated in FIG. 2, preferably one of the current collectors 3 with the current-receiving sprung or spring-loaded electrical contacts 3a; 3b is embedded in the outer lower edge of each shelf 5 in which lighting 4 is desired and connected to a milled groove 8 on the face, through which connecting cables to various installation locations of the desired lighting 4 may be guide. If desired, this milled groove 8 may be closed with a cover, which is cut to fit the particular application.

By means of this arrangement, different types of lights may be supplied with electricity at different locations, without connecting cables passing through the furniture item and negatively affecting the ability of the shelves to be adjusted in height or the ease of disassembly of the item (e.g. in flat-pack furniture).

The only optical consequence of this system is the presence of a single vertical strip on the outside of one of the two side walls 6, which may be an advantageous stylistic feature and, in the event that other furniture items, such as kitchen units, are placed or installed directly next to it, is not even visible. In addition, this system provides the option of embedding the conducting bar 1 in the side wall 6 in such a manner that it is completely covered. Particularly advantageous is the optional use of a (removable or exchangeable) trim piece on the conducting bar 1, which may be attached to the side wall 6 or the conducting bar 1 of the furniture item for the purpose of ornamentation or concealment.

As the conducting bar 1 is contacted through the standard drill holes 7 by means of the pegs 2, it can be integrated invisibly, e.g. through a sandwich method in which e.g. two halves of the side wall 6 are joined together after emplacement of the conducting bar 1 and the joins sealed with edge banding.

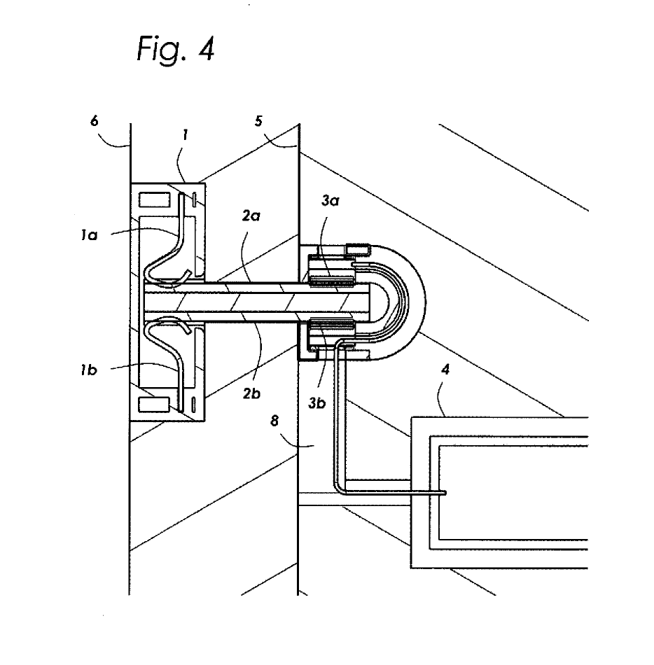

Due to the advantageous separation of the current collector 3 and the lighting 4 depicted in FIG. 1 and FIG. 4, the conducting bar 1 can also be placed e.g. behind a rear row of holes, or at various places on the rear wall of a furniture item. For example, in this arrangement, a double-pole contact located on the shelf could be pushed into the conducting bar 1 in the correct position when the shelf 5 is put in place.

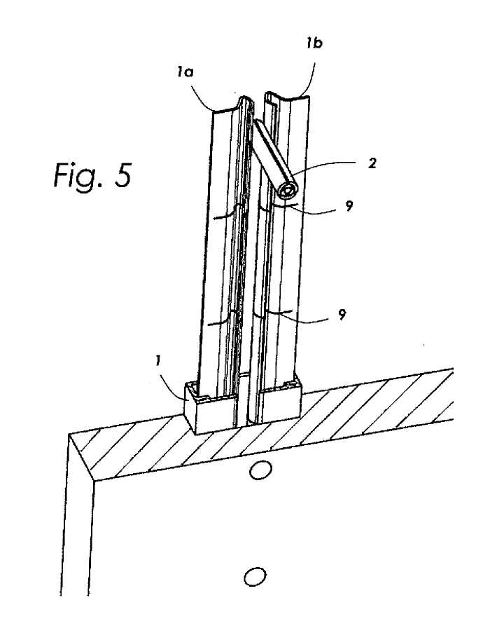

As may be seen from FIG. 5, the electrical contact rails 1a;1b formed preferably continuously on the conducting bar 1 are ideally provided with slots 9 placed at regular intervals, in order that the spring motion of a contact surface not affect the neighboring contact point.

The electrical supply system in accordance with the invention is not limited in its realization to the preferred embodiments set out above. Rather, a multitude of possible embodiments are conceivable which make use of the solution presented herein, even with fundamentally different realization.

### LIST OF REFERENCE NUMBERS

1 Conducting bar

1a;1b Spring-loaded electrical contact rails

2 Current-carrying peg

2a;2b;2c Conductive surfaces on 2

3 Current collector

3a;3b Spring-loaded electrical contacts on 3

4 Lighting

5 Shelf

6 Side wall of a furniture item

7 Standard drill holes

8 Milled groove

9 Slots in the electrical contract rails 1a;1b

What is claimed is:

1. An electrical supply system for lighting of furniture with height-adjustable shelves, comprising:
a conducting bar (1) embedded within a wall (6) having vertically spaced holes (7), the conducting bar (1) comprising two oppositely arranged spring-loaded electrical contact rails (1a, 1b) which are insulated against each other;
at least one shelf (5) comprising a light (4), the at least one shelf being supported by at least one removable cylindrical peg (2) within a hole (7) in the wall (6); and
two oppositely arranged spring-loaded electrical contacts (3a, 3b) embedded within the at least one shelf (5) for receiving the at least one cylindrical peg (2), the spring-loaded electrical contacts (3a, 3b) being electrically connected to the light (4),
wherein the at least one removable cylindrical peg (2) comprises three or more circumferentially separated axially extending electrically conductive surfaces (2a, 2b, 2c) which are insulated against each other, and which separately connect the two spring-loaded electrical contact rails (1a, 1b) with the two spring-loaded electrical contacts (3a, 3b) through the hole (7) in the wall (6).

2. The electrical supply system as in claim 1, wherein the electrical contact rails (1a, 1b) are slotted at regular intervals, thereby allowing the spring loaded contact rails (1a, 1b) to deform independently in segments between two slots.

3. The electrical supply system as in claim 1, wherein the at least one removable cylindrical peg (2) is load-bearing.

4. The electrical supply system as in claim 1, wherein the conducting bar (1) is seated flush within the wall (6).

5. The electrical supply system as in claim 1, wherein the two oppositely arranged spring-loaded electrical contacts (3a, 3b) are arranged at an outer lower edge of the shelf (5).

6. The electrical supply system as in claim 1, further comprising a milled groove (8) for receiving a cable connecting the light (4) with the spring-loaded electrical contacts (3a, 3b).

7. The electrical supply system as in claim 1, further comprising a trim piece which is provided on the conducting bar (1).

8. The electrical supply system as in claim 1, wherein one of the two oppositely arranged spring-loaded electrical contact rails (1a, 1b) is connected to a positive pole and the other is connected to a negative pole.
